(19) United States
(12) Patent Application Publication
(10) Pub. No.: US 2001/0011842 A1
(43) Pub. Date: Aug. 9, 2001

(54) Vehicle wheel

(75) Inventors: Michael Rockl, Mannheim (DE); Paul Smith, Lampertheim (DE)

Correspondence Address: Joel S. Carter, Patent Department, DEERE & COMPANY, One John Deere Place, Moline, IL, 61265-8098, US

(73) Assignee: Deere & Company, a Delaware corporation

(21) Appl. No.: 09/773,023

(22) Filed: Jan. 31, 2001

(30) Foreign Application Priority Data
Feb. 3, 2000 (DE) 200 01 907.4

(51) Int. Cl. B60B 25/00

(52) U.S. Cl. 301/35.62

(57) ABSTRACT

A vehicle wheel includes a wheel rim for mounting a tire thereon and a wheel disc attached to the rim. The wheel disc has an axle mounting flange having a set of wheel bolt holes extending therethrough and arranged in a first inner bolt hole circle for attachment to an axle flange. A reinforcement disc is attached to the wheel disc by bolts. The reinforcement disc has an outer diameter which is larger than an outer diameter of the mounting flange. The wheel disc also includes a mounting ring which is attached to an outer portion of the mounting flange and which projects radially outwardly therefrom. The reinforcement disc has a radial width which is at least twice as large as a radial width of the mounting flange. The wheel bolt holes are used to attach the reinforcement disc to the wheel disc. A further set of bolt holes are formed in the mounting ring, and the reinforcement disc is also attached to the wheel disc by means of bolts which pass through both sets of bolt holes. An annular spacer ring is clamped between the wheel disc and the reinforcement disc.

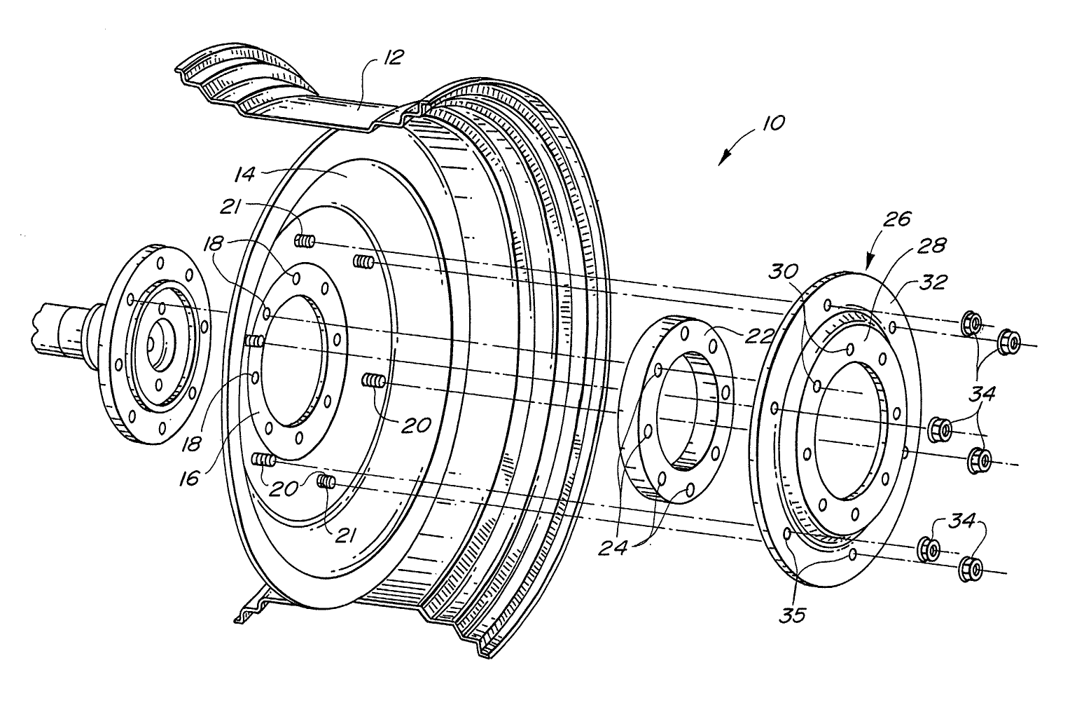

### BACKGROUND OF THE INVENTION

This invention relates to a vehicle wheel with a rim for retaining a tire, a wheel disk which is attached to the rim, and a mounting flange for attachment to an axle flange.

Vehicle wheels with a rim, a wheel disk and a bolt hole circle are used on commercial vehicles. For example, the rear wheels of the John Deere 6000 Series agricultural tractors feature a rim, which includes, on its inner radius, bolt holes arranged in a rim bolt hole circle for attaching the wheel disc by means of bolts and nuts. This wheel disc has a domed shape, and includes a radially inner flat attachment flange that matches the axle flange. Wheel lug bolts are used to attach the metal rim to the axle flange. The wheel lug bolts pass through holes that are positioned on the bolt hole circle that is located within the attachment flange. The wheel lug bolts can be screwed into threaded holes in the axle flange. On a larger diameter weight bolt hole circle positioned outside the attachment flange, the wheel disc includes bolt holes for the attachment of ballast weights.

For cost and manufacturing reasons wheel discs are normally configured to save the largest possible amount of material. However, in order to transfer high forces without deforming, a bowl-shaped wheel disc has been used in lieu of a flat wheel disc. For example, the wheel disc is elbow-shaped between its inner attachment flange and its outer surface which is connected with the rim. It also features two ring-shaped offset areas that are bent in opposite directions. From FR-A-2 756 220 a partially double-walled wheel disc is known. However, such a wheel disc is difficult to manufacture. It is also customary to clamp the wheel disc between a pressure ring and the axle flange, with the external diameters of the pressure ring and the axle flange being approximately equal. However, this leads to a discontinuity in rigidity in the area of the axle flange, where particularly high concentrations of tension occur.

### SUMMARY OF THE INVENTION

Accordingly, an object of this invention is to provide a wheel rim which has flexural strength.

A further object of the invention is to provide such a wheel rim which has substantially uniform rigidity In the area of the highest bending stress.

Another object of the invention is to provide a wheel rim which is easy and cost-efficient to manufacture.

These and other objects are achieved by the present invention, wherein a vehicle wheel includes a wheel rim for mounting a tire thereon and a wheel disc attached to the rim. The wheel disc includes an annular axle mounting flange which has a set of wheel bolt holes extending therethrough and arranged in a first bolt hole circle for attachment to an axle flange. A reinforcement disc is attached to the wheel disc by bolts, and the reinforcement disc has an outer diameter which is larger than an outer diameter of the mounting flange. With such a larger diameter reinforcing disc, stress concentrations in the axle mounting flange area are reduced and diverted with flexible transition into the outer parts of the wheel disk. Preferably, the wheel disc and the reinforcement disc both have bowl-shaped inner portions, and are joined together so that a hollow space is formed between wheel disc and reinforcement disc. A concentric spacer ring is mounted in this hollow space and is clamped therebetween. The radial dimensions of the spacer ring are preferably the same as the radial dimensions of the mounting flange. Preferably, the wheel bolt hole circle is also used to attach the spacer ring between the reinforcement disc to the wheel disc.

Preferably, the reinforcing disc features twice the radial width of the radial width of the axle mounting flange. The inner diameters of the mounting flange and of the reinforcement disc can be of approximately the same size, so that the external diameter of the reinforcement disc is significantly larger than that of the mounting flange. The tensile forces, in this configuration, do not concentrate at the highly stressed axle flange area but instead are diverted into a zone with a larger radius. In order to reduce the number of bolts and drilled holes, and in order to avoid weakening the wheel disc with additional holes, the wheel bolt holes are used to mount the reinforcement disc to the wheel disc.

Preferably, the reinforcement disc is mounted on the wheel disc by means of bolts which are arranged in two bolt hole circles. The bolt hole circles are preferably concentric with the axle mounting flange and with each other. For example, the reinforcement disc is attached to the wheel disc by wheel bolts on the wheel bolt hole circle, and is bolted to the wheel disc at a further bolt hole circle of a larger diameter. This transmits forces to an area which is radially outwardly of the wheel bolt hole circle. The outer bolt hole circle can be used for the attachment of weights, as well for attaching the reinforcement disc to the wheel disc. In this manner the number of holes and bolts can be reduced.

Preferably, the diameter of the outer bolt hole circle is between 20% and 150% larger than the diameter of the inner wheel bolt hole circle. For example, wheel bolt hole circles on tractors typically have diameters of 275 mm (standard), 203 mm and 335 mm, while the diameter of a customary weight bolt hole circle is 430 mm. Different wheel bolt hole circles can be used in conjunction with the weight bolt hole circle as the inner and outer mounting hole circles for the attachment of reinforcement disc to the wheel disc. Alternatively, a rim bolt hole circle could also be used for the attachment of the reinforcement disc to the wheel disc.

Preferably, in order to save tooling costs, the reinforcement disc has a shape which essentially corresponds to the shape of the radially inner portion of the wheel disc so that it can be manufactured from an existing wheel disc. For example, a wheel disc is produced using a die-stamping tool. The middle part is cut out of the wheel disc and serves as a reinforcement disc. The wheel disc and the reinforcement disc can thus be produced using the same die-stamping tool.

The bowl shape increases the rigidity and flexural strength of the wheel disc and of the reinforcement disc. The spacer ring fills the intermediate space. The result is a relatively large distance between the wheel disc and the reinforcement disc, so that relatively long necked-down bolts must be used in order to mount the wheel on the rim. This is advantageous, since, due to the large elongation length of the wheel bolts the spring travel of the pre-stressed bolts is longer than usual and the spring forces that occur with changes in length remain approximately the same.

### BRIEF DESCRIPTION OF THE DRAWINGS

The sole FIGURE is an exploded perspective view of a wheel rim according to the present invention.

### DETAILED DESCRIPTION

A vehicle wheel 10 includes a conventional wheel rim 12 is adapted for mounting thereon a tire (not shown). A wheel disc 14 is attached to the wheel rim 12, such as by welding, and projects radially inwardly therefrom. Alternatively, the wheel disc 14 may also be bolted to the wheel rim 12 via a circular array of wheel rim bolts (not shown).

The wheel disc 14 includes an annular hollow axle mounting flange 16, which is located radially inwardly with respect to the rim 12. The non-visible back wall of flange 16 abuts against an axle flange 17. Flange 16 includes holes 18 which are located on an inner concentric wheel bolt hole circle in a central portion of the mounting flange 16. These holes 18 receive wheel lug bolts (not shown) which are threaded into threaded holes (not shown) in the axle flange 17 in order to attach the wheel 10 to the axle flange 17. A portion of disc 14 also forms an annular mounting ring 36 which is attached to and projects radially outwardly from the outer portion of flange 16.

The wheel disc 14 has a domed shape so that its radially inner portion is spaced axially inwardly (toward the axle flange 17) with respect to its radially outer portion. A circular concentric array of threaded bolt ends 20 project through corresponding array of bolt holes 21 which are formed in the ring 36 and arranged in an outer bolt hole circle. The outer bolt hole circle has a diameter which is between 20% and 150% larger than a diameter of the first inner bolt hole circle. Ballast weights (not shown) may be attached to the bolts 20.

An annular spacer ring 22 has internal and external diameters which are approximately the same as the corresponding diameters of the mounting flange 16. The spacer ring 22 includes holes 24 which extend axially through the spacer 22 and which are located on a hole circle that corresponds with the wheel bolt hole circle.

A reinforcement disc 26 has a dome shape which corresponds with the form of the radially inner portion of the wheel disc 14, and is positioned so that its radially inner portion projects axially away from the wheel disc 14. Disc 26 includes a radially inner annular ring 28 which corresponds with the mounting flange 16 of the wheel disc 14, and against which the spacer ring 22 engages. Holes 30 are located in ring 28 and are positioned on the wheel bolt hole circle. Disc 26 also includes radially outer annular ring 32. Flange nuts 34 are positioned adjacent an array of bolt holes 35 which extend through ring 32 and which are positioned on an outer bolt hole circle, which corresponds to the outer bolt hole circle of bolts 20. The bolts 20 extend through bolt holes 35 so that the flange nuts 34 can be screwed onto them. Since the reinforcement disc 26 has a shape which is similar to the shape of the wheel disc 14, it can be manufactured from an existing wheel disc 14.

When assembled, the ring 32 of the reinforcement disc 26 abuts against the corresponding ring 36 of the wheel disc 14. The thickness of the spacer ring 22 is preferably selected so that the spacer ring 22 is clamped in between the ring 28 of the reinforcement disc 26 and the mounting flange 16 of the wheel disc 14. The flange nuts 34 are screwed onto the bolts 20 that extend through the holes 21, located on the outer bolt hole circle, of the wheel disc 14 and through the holes of the reinforcement disc 26. The assembled wheel 10 may then be mounted on the axle flange 17 by means of wheel lug bolts (not shown), by passing the wheel lug bolts through the holes 30, 24 and 18, of the reinforcement disc 26, the spacer ring 22 and the wheel disc 14 and by screwing them into the corresponding threaded holes of the axle flange 17.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims. For example, different diameters can be selected for the mounting hole circles than that of the wheel bolt hole circle and that of the weight hole circle. This invention can be used in connection with bowl-shaped and with flat wheel disks.

1. A vehicle wheel, having a wheel rim (12) for mounting a tire thereon and a wheel disc (14), attached to the rim, the wheel disc having an axle mounting flange 16 having a set of wheel bolt holes extending therethrough and arranged in a first bolt hole circle for attachment to an axle flange, characterized by:
a reinforcement disc (26) attached to the wheel disc (14) by bolts, the reinforcement disc having an outer diameter which is larger than an outer diameter of the mounting flange.

2. The vehicle wheel of claim 1, wherein:
the disc 14 also includes a mounting ring 36 which is attached to an outer portion of flange 16 and which projects radially outwardly therefrom; and
the reinforcement disc (26) has a radial width which is at least twice as large as a radial width of the mounting ring (36).

3. The vehicle wheel of claim 1, wherein:
the wheel bolt holes are used to attach the reinforcement disc (36) to the wheel disc (14).

4. The vehicle wheel of claim 1, wherein:
a further set of bolt holes are formed in the mounting ring; and
the reinforcement disc (26) is attached to the wheel disc (14) by means of bolts which pass through both sets of bolt holes.

5. The vehicle wheel of claim 4, wherein:
the further set of bolt holes are arranged in a further bolt hole circle; and
the further bolt hole circle has a diameter which is larger than a diameter of the first bolt hole circle.

6. The vehicle wheel of claim 1, wherein:
a further set of bolt holes are formed in the mounting ring;
the reinforcement disc (26) is attached to the wheel disc (14) by means of bolts which pass through said further set of bolt holes, said bolts also being capable of connecting to wheel weights.

7. The vehicle wheel of claim 4, wherein:
the further bolt hole circle has a diameter which is between 20% and 150% larger than a diameter of the first bolt hole circle.

8. The vehicle wheel of claim 1, wherein:
the reinforcement disc (26) has a shape which is similar to a shape of the wheel disc.

9. The vehicle wheel of claim 1, wherein:
both the wheel disc (14) and the reinforcement disc (26) have a concave shape, and the spacer ring (22) is positioned in a hollow space formed between the wheel disc (14) and the reinforcement disc (26).

10. The vehicle wheel of claim 10, wherein:
the wheel bolt holes are used to attach the spacer ring (22) and the reinforcement disc (26) to the wheel disc (14).
